(19) United States
(12) Patent Application Publication
(10) Pub. No.: US 2016/0007405 A1
(43) Pub. Date: Jan. 7, 2016

(54) TIMING DETERMINING DEVICE, TIMING DETERMINING METHOD, AND NON-TRANSITORY COMPUTER READABLE MEDIUM

(71) Applicant: KABUSHIKI KAISHA TOSHIBA, Tokyo (JP)

(72) Inventors: Takeshi ISHIHARA, Yokohama (JP); Yuichiro OYAMA, Tokyo (JP); Hiroshi NISHIMOTO, Yokohama (JP)

(21) Appl. No.: 14/755,158

(22) Filed: Jun. 30, 2015

(30) Foreign Application Priority Data
Jul. 7, 2014 (JP) 2014-139884

(51) Int. Cl. H04W 76/04; H04W 52/02; H04W 4/04

(52) U.S. Cl. CPC H04W 76/048; H04W 4/04; H04W 52/0245

(57) ABSTRACT

According to one embodiment, a timing determining device used in a mobile terminal, includes processing circuitry. The processing circuitry performs a detecting process of whether the mobile terminal is positioned at a reference point being a point at which a predetermined condition is satisfied for the mobile terminal. The processing circuitry employs feasibility data representing relationship between an adequacy of a communication environment and elapsed time from a start time point at which the mobile terminal is positioned at the reference point, estimates elapsed time until the adequacy satisfies a communication condition since the mobile terminal is positioned at the reference point and determines a timing of evaluating the communication environment according to an estimated elapsed time. The processing circuitry determines whether to permit the mobile terminal to perform communication on basis of measurement of the communication environment at the timing determined.

### CROSS-REFERENCE TO RELATED APPLICATIONS

This application is based upon and claims the benefit of priority from Japanese Patent Application No. 2014-139884, filed Jul. 7, 2014; the entire contents of which are incorporated herein by reference.

### FIELD

Embodiments of the present invention relate to a timing determining device, a timing determining method, and a non-transitory computer readable medium.

### BACKGROUND

For mobile communicating devices that are driven by batteries, a technique is known that suppresses a waste of energy by controlling communication timings when a radio wave environment is not preferable for communication. For example, a method has been proposed that learns positional information obtained by the GPS and a radio wave condition of the place, and refrains from communication until a current position matches a location at which a preferable radio wave condition is recorded. In addition, a technique has been proposed that temporarily saves a communication request issued by an application, determines whether the request can be transmitted, and refrains from transmitting the request until the request is determined to be able to be transmitted.

With the above-described conventional techniques, however, accurate leaning may not performed in a circumstance such as an indoor environment where the GPS functions poorly. In addition, in the case of a narrow range of communication, like a wireless LAN, transmission may not be performed at an appropriate timing due to a measurement error. Furthermore, timing to evaluate a communication environment is not well-defined, which possibly results in a waste of energy. For example, it is conceivable to repeat an environment evaluation from the occurrence of a certain communication request until the communication request is feasible (e.g., can be transmitted). This method requires the GPS, a communication interface or the like to operate all the time, which consumes energy for the environment evaluation itself.

### BRIEF DESCRIPTION OF THE DRAWINGS

FIG. 1 is a functional block diagram of a communicating device in a first embodiment;

FIG. 2 is a diagram where a sensor is disposed in the communicating device;

FIG. 3 is a diagram showing feasibility data in the form of a graph;

FIG. 4 is a diagram where the feasibility data is expressed as discrete values;

FIG. 5 is a diagram showing a flow chart of the operation of the communicating device;

FIG. 6 is a functional block diagram of a communicating device in a second embodiment;

FIG. 7 is the other functional block diagram of the communicating device in the second embodiment;

FIG. 8 is a schematic diagram showing an operation image of a timing determiner in the second embodiment;

FIG. 9 is an explanatory diagram of an example of temporarily changing the feasibility data;

FIG. 10 is an explanatory diagram of an example of correcting the feasibility data;

FIG. 11 is an explanatory diagram of an example of changing an interval between determination timings based on how the adequacy comes close to a threshold value;

FIG. 12 is a diagram showing an example of a plurality of feasibility data sharing a reference point;

FIG. 13 is a diagram showing environment information given to the feasibility data;

FIG. 14 is a diagram showing an example of adjusting elapsed time managed by a time keeper;

FIG. 15 is a schematic diagram showing the feasibility data and information on use timing;

FIGS. 16A and 16B are diagrams showing the feasibility data and the information on use timings in a tabular form, respectively; and

FIG. 17 is a diagram showing an example in which a plurality of threshold values are set to the feasibility data according to respective priorities.

### DETAILED DESCRIPTION

A timing determining device as an embodiment of the present invention is a timing determining device used in a mobile terminal, and includes a detector, a first determiner, and a second determiner. The detector performs a detecting process of whether the mobile terminal is positioned at a reference point. The first determiner employs feasibility data representing relationship between an adequacy of a communication environment and elapsed time from a start time point at which the mobile terminal is positioned at the reference point, specifies elapsed time until the adequacy satisfies a communication condition since the mobile terminal is positioned at the reference point and determines a timing of evaluating the communication environment according to an estimated elapsed time. The second determiner determines whether to permit the mobile terminal to perform communication on basis of measurement of the communication environment at the timing determined by the first determiner.

Embodiments of the present invention will be described below with reference to the drawings. Each embodiment described below is merely an example, and the present invention is not necessarily practiced in modes identical to them.

### First Embodiment

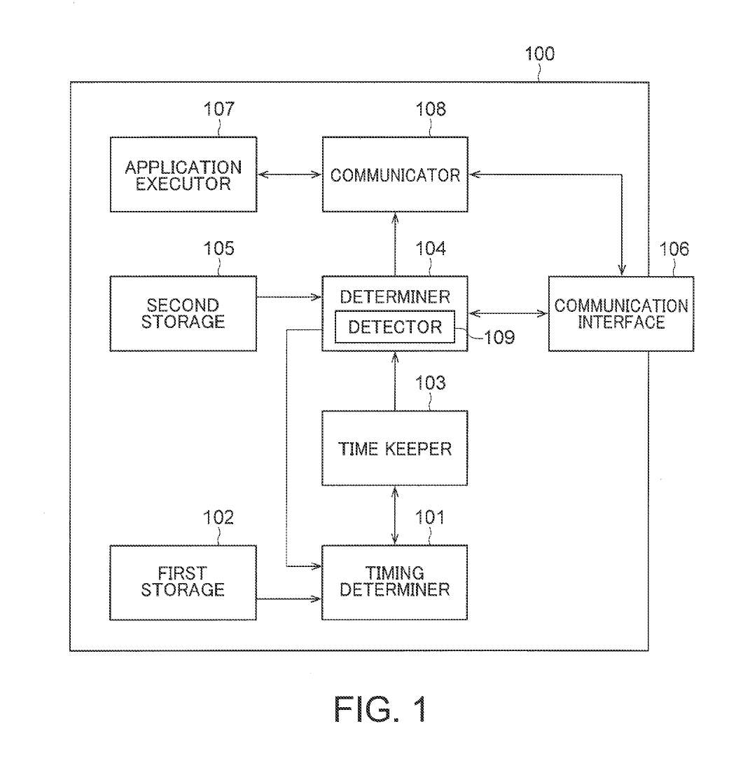

FIG. 1 shows a functional block diagram of a communicating device 100 in a first embodiment. The communicating device 100 includes a timing determiner 101, a first storage 102, a time keeper 103, a determiner 104, a second storage 105, a communication interface 106, an application executor 107, a communicating section 108. The determiner 104 includes a detector 109, and the set of the determiner 104, the detecting section 109, and the timing determiner 101 form a timing determining device. The timing determining device may be defined including such as the other processor or storage such as the time keeper 103. This communicating device can be equipped in a mobile terminal held by a user. The mobile terminals may be any terminals as long as they can be carried about, and includes, for example, a smartphone, laptop PC, tablet computer, and mobile phone. Note that the blocks of elements that are not directly involved in the essence of the present embodiment will not be described. All or some of the blocks in FIG. 1 may be configured by processing circuitry as one example. The processing circuitry may be configured of one circuitry, or two or more circuitry. As one example, the detector 109, the timing determiner 101, and the determiner 104 may be configured by one circuitry, or, the detector 109 may be configured by a first circuitry, the timing determiner 101 may be configured by a second circuitry, and the determiner 104 is configured by a third circuitry, or, the detector 109 and the determiner 104 may be configured by a first circuitry and the timing determiner 101 may be configured by a second circuitry. Configuration examples other than those described herein are obviously possible. The term “circuitry” may indicate one circuit, a plurality of circuits, or a system of circuits as one example.

The communication interface 106 is an interface for connecting this communicating device 100 to a wired or wireless communication network. As the communication interface 106, any communication interface can be used. For example, conceivable one is a communication interface compliant with the IEEE 802.11. The communication environment of the communication network, which is to be connected by the communication interface 106, is supposed to change dynamically, and the communication condition of the communication interface 106 is supposed to be changed dynamically, accordingly.

The application executor 107 is a section that executes an application that operates in the communicating device 100, and corresponds to, for example, an application processor. The application executor 107 issues a communication request as part of the operation. The communication request may be any request including, for example, a request for the transmission of data to the communicating device via the communication network, and a request for the access to the communication network or a server on the other network (e.g., the Internet) via the communication network.

The communicator 108 is a section that performs a communication process (e.g., the TCP/IP) that is necessary when the application communicates with the communication network. The communicator 108 notifies, when the application executor 107 issues a communication request, the issue of the communication request to the determiner 104, and stores the communication request therein. When receiving from the determiner 104 the notification of permission to perform the request communication, the communicator 108 performs the communication via the communication interface 106. As the communicator 108, for example, a TCP/IP hardware engine can be used. The communicator 108 is described here as a functional element that is separate from the application executor 107, but may be implemented as software that operates on the application processor on which the application executor 107 also operates.

The first storage 102 stores feasibility data which represent relationship between elapsed time information and feasibility data: the elapsed time information includes a time period that elapses from a start time point, which is a time point at which the mobile terminal is positioned at a reference point that meets a predetermined condition; and the feasibility data representing an adequacy of the communication environment. In other word, the feasibility data represents chronological variations in the communication environment since the mobile terminal is positioned at the reference point. The first storage 102 stores the feasibility data for each reference point. A plurality of feasibility data may be provided to the same reference point. The adequacy is a value expressing how appropriate performing the communication is (the degree of adequacy of the communication environment), and will be described hereafter in detail.

The elapsed time information may represent the time period itself that elapses since the mobile terminal is positioned at the reference point, but is not limited to this, and may be any parameter as long as it increases monotonously and uniquely from the reference point. For example, assuming that the device is equipped with an accelerometer to have a function of counting the number of vibrations like pedometers, the elapsed time information may be determined as the number of times that the value from the accelerometer exceeds a given value. Alternatively, if signals can be received regularly from an external communicating device via the communication interface 106 (or the other communication interface that is not shown), the elapsed time information may be determined as the number of receptions of the signals.

In the following description, the elapsed time information is supposed to represent, as an example, the time period itself that elapses since the mobile terminal is positioned at the reference point.

The examples of the reference point include a position at which the mobile terminal is determined to leave a place such as one's own house, a school, and an office, more specifically a position at which the mobile terminal becomes to be disable to communicate with a communication station installed at the place, a position at which a certain BSSID or SSID, or the ID of the communication station can (or cannot) be acquired, and the like.

In addition, the first storage 102 stores information represent a communication condition. The communication condition provides a condition of the adequacy with which the communication can be performed. The communication condition is, for example, the excess of a threshold value, and in this case, the criterion can be determined to be met, which means that the communication can be performed, when the calculated adequacy exceeds the threshold value. The communication condition is not limited to the excess of the threshold value, and the communication condition may be determined by, for example, with a temporal condition added, the continuation of a state that the calculated proper value being equal to or more than the threshold value for a certain period of time (i.e., a constant period of time). Alternatively, the communication condition may be determined by a statistic (e.g., average value) of adequacies calculated over a certain period of time being equal to, or more or less than the threshold value. The description will be made below assuming that the communication condition is the excess of the threshold value, but is not limited to this.

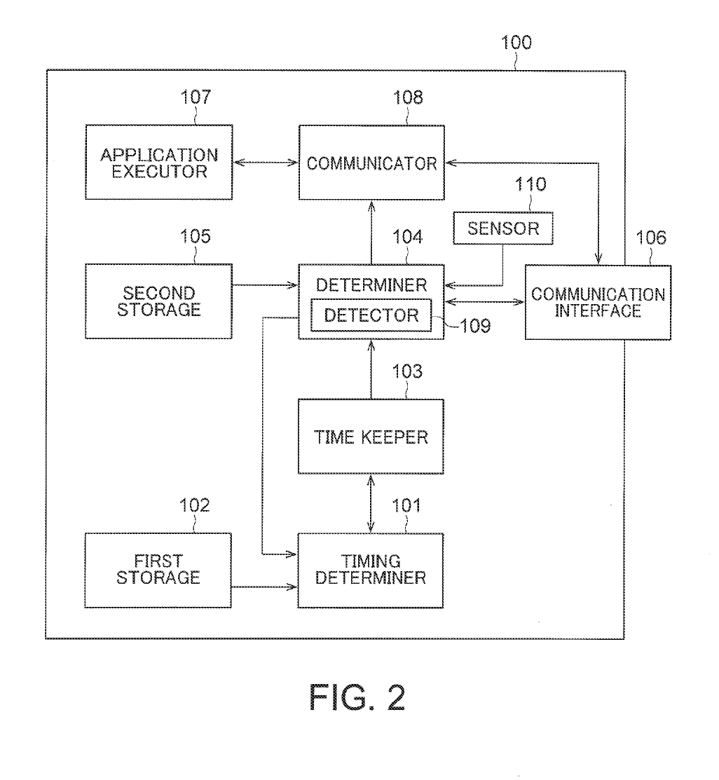

The detector 109 in the determiner 104 performs, when the application executor 107 issues a communication request, a detecting process of whether the mobile terminal of a user is positioned at the reference point. The detecting process of detecting whether the mobile terminal is positioned at the reference point can use, for example, the information acquired from the communication interface 106, or if the communicating device 100 includes a sensor 110 such as an accelerometer and a GPS sensor as shown in FIG. 2, a detected value from the sensor 110. The detecting process for the reference point will be described hereafter in detail. The detector 109 transmits, when detecting that the mobile terminal has been positioned at the reference point, the notification of the detection to the time keeper 103. When receiving the notification of the detection, the time keeper 103 considers the notified time point to be a time point at which the mobile terminal is positioned at the reference point, and starts keeping time beginning from this time point as a start point.

In addition, the detector 109, when detecting that the mobile terminal has been positioned at the reference point, notifies information on the detected reference point to the timing determiner 101. When receiving the notification of the detected reference point, the timing determiner 101, which is connected to the first storage 102, reads feasibility data corresponding to the detected reference point, from the first storage 102. The timing determiner 101 then calculates elapsed time taken for the adequacy to exceed the threshold value (to meet the communication condition), based on the read feasibility data. That is, the timing determiner 101 calculates elapsed time representing how long it takes since the mobile terminal is positioned at the reference point until the adequacy exceeds the threshold value. This elapsed time can be estimated at elapsed time taken for the mobile terminal to be actually positioned at a position at which the adequacy exceeds the threshold value. The timing determiner 101 determines the evaluation of the communication environment and a determination timing being a timing at which whether to perform the communication is determined based on the evaluation of the communication environment, according to the calculated elapsed time. The timing determiner 101, which is connected to the time keeper 103, notifies the elapsed time up to the determination timing (the start point is set to, for example, a time point at which the reference point is detected) to the time keeper 103.

After the notification to the time keeper 103, a power controlling function in the mobile terminal may switch all or a part of portions of the communicating device 100 relating to the communication into a sleeping state. For example, the power supply to all or a part of the communicator 108 is turned off. The power controlling function may be included in any processing block in the communicating device 100, or may exist as a single processing section. For example, the power controlling function may be included in the determiner 104. In this case, the timing determiner 101 notifies, after the notification to the time keeper 103, the elapsed time up to the determination timing to the determiner 104. The power controlling function of the determiner 104 performs the switch into the sleeping state in response to the notification. Alternatively, the power controlling function may be installed in a processor (e.g., a CPU), or in the timing determiner 101. A specific example will be as well described in a second embodiment in further detail.

The time keeper 103 sets an internal timer such that it expires at a time point (timing) after the elapsed time instructed by the timing determiner 101. The time keeper 103, which is connected to the determiner 104, notifies the coming of the determination timing to the determiner 104 when finishing counting.

The determiner 104 causes the processing section in the sleeping state to return from the sleeping state based on the notification of the coming of the determination timing from the time keeper 103. The determiner 104 performs a determining process of whether to allow the above-described the communication relating to the communication request based on the measurement of the communication environment by means of the communication interface 106 or the sensor 110 (refer to FIG. 2). In the determining process, the determiner 104 performs a simple evaluation and a detailed evaluation of the communication environment, and determines to allow the communication when these evaluations show positive results. The simple evaluation has a simpler operation and consumes less power than the detailed evaluation. By performing the detailed evaluation when the communication is determined to be feasible in the simple evaluation, or not performing the detailed evaluation when the communication is determined to be infeasible in the simple evaluation, an operation with low power consumption is achieved. Note that performing in such a manner the evaluation of the communication environment in two stages is not essential to the present embodiment. The determiner 104 may be configured to perform only the simple evaluation.

The determiner 104 performs the following process in the simple evaluation. The determiner 104, which is connected to the communication interface 106, acquires information on the communication environment from the communication interface 106. The determiner 104 calculates the adequacy from the acquired information on the communication environment. The calculation method for the adequacy will be described in detail later. The determiner 104 determines whether the calculated adequacy exceeds the threshold value. This threshold value may be identical to or different from the threshold value used in the timing determiner 101 (assume that the same applies to the following description). When the calculated adequacy exceeds the threshold value, the determiner 104 determines in the simple evaluation that the communication is feasible, that is, the communication is feasible in the environment, and when the calculated adequacy is equal to or less than the threshold value, the determiner 104 determines that the communication is infeasible, that is, the environment is inadequate to perform the communication. When determining the communication to be feasible in the simple evaluation, the determiner 104 performs the detailed evaluation in the second stage. Note that the determiner 104 can be configured to use the detected value from the sensor 110 in addition to the information acquired from communication interface 106, according to the calculation method for the adequacy.

The sensor 110 corresponds to a sensor such as an accelerometer (monitoring an acceleration, a gravitational acceleration, or the like that change with the movement and is used as the basis for the determination of moving state of the terminal), angular velocity sensor (monitoring the rotating operation of the terminal to detect a special operation or the like), magnetic sensor (monitoring geomagnetism or residual magnetism existing around the terminal to detect a bearing or a specific place), illuminance sensor (detecting luminosity around the terminal that is used as the basis for the determination of whether to be indoors or outdoors), temperature sensor, camera (utilizing captured information on the surroundings, or obtaining information through optical communications), speaker (utilizing sound as the basis for the specification of a place), and GPS (specifying an absolute position). Pieces of information collected intermittently or continuously by these can be independently used or may be used in combination.

The determiner 104 determines in the detailed evaluation whether to allow the communicator 108 to perform the communication based on an environment evaluation rule stored in a second storage 105, and the measurement of the communication environment by means of the information acquired from the communication interface 106 or the sensor 110. The environment evaluation rule represents a communication condition relating to an indicator different from the adequacy. The environment evaluation rule will be described hereafter in detail.

The determiner 104 determines in both the simple evaluation and the detailed evaluation to allow the performing of the communication when determining the performing of the communication to be feasible, or not to allow the performing of the communication when determining the performing of the communication not to be feasible in any one of the evaluations. When allowing the performing of the communication, the determiner 104 outputs an instruction to perform the communication to the communicator 108, or otherwise does not output the instruction to perform the communication. When receiving the instruction to perform the communication, the communicator 108 performs the communication relating to the communication request held inside. If holding inside a plurality of communication requests, the communicator 108 processes the communication requests in an order determined by any method, such as giving high priority to a communication request that is issued earlier.

Alternatively, the communicator 108 can control the order of the communication requests to be processed by setting priorities to the communication requests, as will be described in an embodiment to be described hereafter.

Note that the first storage 102 and the second storage 105 are separately shown in FIG. 1, but they may be configured on the same hardware.

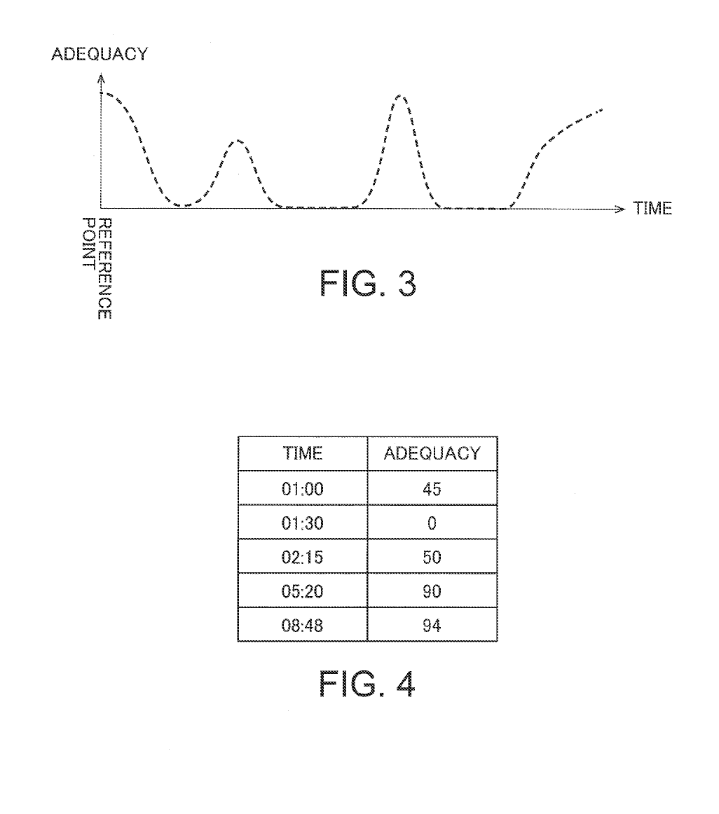

FIG. 3 is a diagram showing the feasibility data stored in the first storage 102 in the form of a graph. The horizontal axis denotes time elapsing from the time point at which it is detected that the mobile terminal is positioned at the reference point, and the vertical axis denotes the adequacy of the communication environment. Note that with the time point of the reference point set to zero, the time point on the graph matches the elapsed time.

The reference point is, as described above, a position at which the predetermined condition is met, and includes a position at which the mobile terminal is detected having left a main place, or a position that meets a condition having a feature about the communication environment. For example, if the SSID of a wireless LAN or the BSSID of an access point in one's own house cannot be detected, it can be determined that the user of the communicating device 100 has left one's own house to go out. In this case, the reference point may be set to a position at which the user of the communicating device 100 can be considered to leave the one's own house, and actually, a position at which the SSID cannot be detected. Similarly, if the SSID of a wireless LAN or the BSSID of an access point that can be detected in an office cannot be detected, it can be considered that the user has left the office, and the reference point may be set to a position at which the SSID or the BSSID cannot be detected.

With respect to the reference point, a place at which the detector 109 in the determiner 104 satisfies a certain condition is automatically extracted as the reference point. Determining the satisfaction of the condition uses information that is acquired via one of the communication interface 106 (not limited to the shown communication interface 106 and may be the other not-shown communication interface), a timepiece (may be included in the time keeper 103), and the various sensors. For example, it is conceivable that the reference point is set to a place at which the width or rate of change in a value from the sensor exceeds a predetermined value, or a certain SSID cannot be acquired. The extracted reference point may be stored as reference point information being associated with the identifier of the reference point, and information (e.g., the value of the SSID) that is the basis of extracting the reference point. The condition of the reference point (e.g., changes in values from the sensors featuring the reference point, and changes in information acquired from the communication interface 106) may be specified clearly by a user via a user interface (not shown), or may be set in advance in any storage in the communicating device.

Note that, the information to be the basis of extracting the reference point does not necessarily contain the information on the communication interface 106 (e.g., information on the wireless LAN). For example, a timing (a timing of leaving a school) may be specified by determining comprehensively a time point at which a certain operation occurs, and the value from the accelerometer featuring the operation and sound from the surrounding environment. In this case, the set of the time point, the value from the accelerometer, and the value of the sound from the surrounding environment is information to extract the reference point. That is, the condition of extracting the reference point includes a condition relating to the set of values.

Besides the methods described here, the reference point can be detected by various methods. It is however desirable not to use too many sensors. This is because using many sensors and pieces of information allows the reference point to be specified more correctly, whereas increases energy necessary to collect the information.

The adequacy of the communication environment is a value representing whether the performing of the communication is feasible (the degree of adequacy of the communication environment). The examples thereof include one in which the adequacy can be expressed by the strength of a radio signal received from an access point compliant with the IEEE 802.11. Since receiving a stronger radio signal brings about a more preferable communication environment, the adequacy can be expressed by, as an example, setting a value of the case where a necessary and sufficient strength (first strength) is acquired as the maximum value of the adequacy, and setting a value of the case where even a minimum strength necessary to perform the communication (second strength) is not acquired as the minimum value of the adequacy. In this case, the adequacy ranges between the minimum value and the maximum value. That is, a value obtained by normalizing the strength of the radio wave within the range between the minimum value and the maximum value is defined as the adequacy. This method is merely an example and the adequacy may be expressed by the other kind of information. For example, the adequacy may be expressed by the strength of the radio wave itself. Alternatively, a value may be derived by performing a certain computation on a plurality of pieces of information to calculate the adequacy. At this point, the plurality of pieces of information may or may not contain the strength information on the radio wave, as one of the pieces of information.

Here, the adequacy of the communication environment may be determined under predetermined operation criteria for the communicating device. The operation criteria are criteria for controlling a processing speed, energy necessary for the process, communication costs, and the like. For example, the criteria include giving a priority to battery run time (reducing the amount of energy consumed), giving a priority to operating speed, allowing or not allowing a communication delay, selecting a communication channel with which communication charges is minimized, and selecting a communication channel by which a transmission speed is maximized. In the case where there are a plurality of operation criteria, feasibility data have different contents even the reference point of which are the same start point. In the above-described example of the radio wave, the values of the first strength and second strength differ for each operating criterion. The adequacy of the communication environment can be defined without providing such operation criteria.

The graph in FIG. 3 shows that the adequacy continuously changes with the time, it may be difficult for a computer to handle continuous values. Thus, the feasibility data may be expressed as discrete values, and an example of this case is shown in FIG. 4. In this example, the feasibility data has a plurality of row data. Each row data has the values of time and adequacy. The time represents elapsed time from the detection of the reference point. In the example of the drawing, the adequacy 1 minute later from when the mobile terminal is positioned at the reference point is 45. Note that, any intervals between adjacent two row data can be set, but minimum required intervals must be kept. Each data between each two adjacent rows may be calculated and used by interpolation such as linear interpolation.

In addition, in the first storage 102, as described above, the communication condition (e.g., the threshold value) is stored. If there are the plurality operation criteria, the communication condition (e.g., the threshold value) may be provided for each operation criteria. In this case, a different communication condition may be used for each operating criterion, or the same communication condition may be used.

In the second storage 105, as described above, the environment evaluation rule is stored. The environment evaluation rule is a rule to evaluate the communication environment from a viewpoint different from the adequacy. The environment evaluation rule determines conditions relating to, for example, the speed of a data link layer, an application throughput, delay or jitter, or various indicators relating to a signal obtained from the received radio wave (e.g. RSSI, SNR, SIR, and BER). The determiner 104 evaluates the communication environment by means of the environment evaluation rule, and information acquired from the communication interface 106 or the sensor 110 (detailed evaluation). For example, if the environment evaluation rule includes a condition that the speed of a data link layer is equal to or more than a certain value, the determiner 104 acquires the link speed of a communication channel established by the communication interface 106 and evaluates whether the acquired link speed satisfies the condition. If the acquired link speed is equal to or more than the certain value, the determiner 104 determines that the communication is feasible, or if the acquired link speed is less than the certain value, determines that the communication is infeasible. In addition, if the environment evaluation rule includes a condition of the application throughput, the determiner 104 transmits/receives some kind of data to/from a counterpart or a counterpart for evaluation and calculates a throughput to evaluate whether the condition is satisfied. Furthermore, if it is necessary to acquire information on the other communicating device via the communication interface 106 (or via the other not-shown communication section), the determiner 104 may be configured to acquire the necessary information. The environment evaluation rule may be defined to include a plurality of conditions such as one relating to a delay, in addition to the condition of the speed of the data link layer. Note that the environment evaluation rule may be defined not to include the speed of the data link layer. The environment evaluation rule may be defined according to the operating criterion, and in this case, the environment evaluation rule to be used may by specified in the second storage 105 according to the operating criterion to be used, and used.

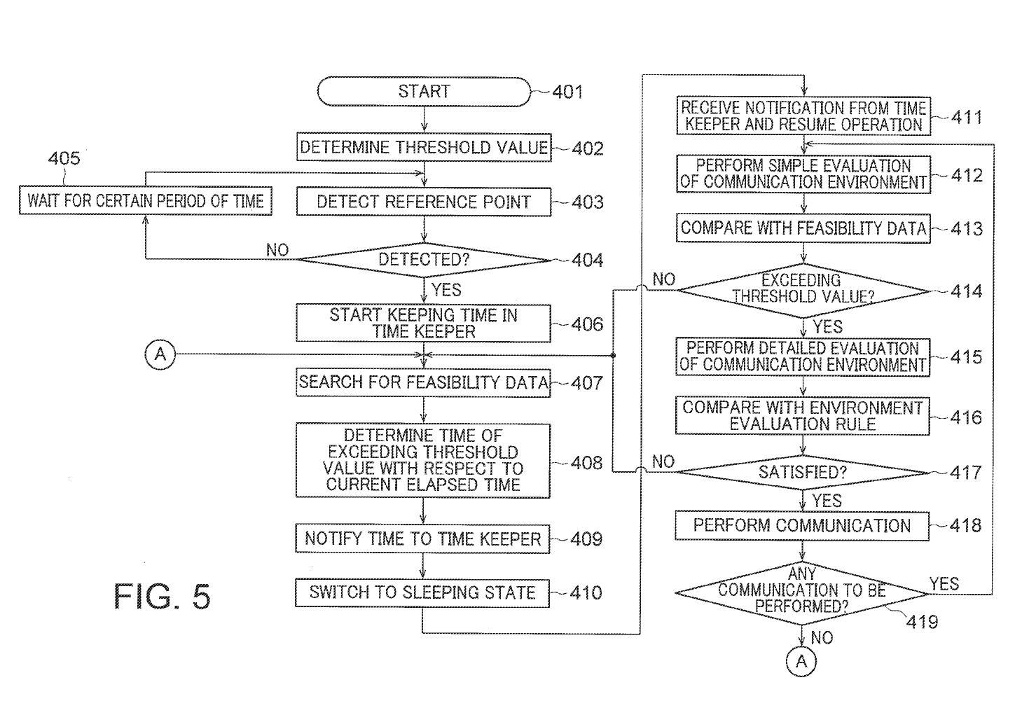

FIG. 5 shows a flow chart of the operation of this communicating device 100. This flow chart is executed by any trigger (step 401). It is assumed here that the occurrence of a communication request in the application executor 107 acts as the trigger, and giving an instruction by a user via an interface (not shown) may act as the trigger. In addition, at this point, if there are the plurality of operating criteria, an operating criterion to be used is determined. Any method may be used to determine an operating criterion. For example, the operating criterion may be instructed by the user via the user interface (not shown), or may be determined according to the remaining battery level of the mobile terminal by the timing determiner 101 or the other processing section. As the operating criterion, an operating criterion that is set in advance may be used. The operating criterion may be determined before the start trigger of this flow occurs or after the trigger occurs.

The determiner 104 specifies, based on the operating criterion to be used, a corresponding threshold value in the first storage 102, and determines to use this threshold value (step 402). The detector 109 in the determiner 104 detects whether the mobile terminal has been positioned at the reference point using information acquired via the communication interface 106 or the like (step 403). If the detector 109 cannot detect that the mobile terminal has been positioned at the reference point (No in step 404), the detector 109 detects again whether the mobile terminal has been positioned at the reference point after waiting for a certain period of time (step 405). In contrast, if the detector 109 detects that the mobile terminal has been positioned at the reference point (YES in step 404), the detector 109 instructs the time keeper 103 to start counting time beginning from the detected time point as a start point (step 406). The time keeper 103 counts the time elapsing from when the mobile terminal is positioned at the reference point, in response to the instruction from the determiner 104 (the same step 406).

In addition, the determiner 104 instructs the timing determiner 101 to operate. At this point, the determiner 104 notifies the threshold value specified in step 402 to the timing determiner 101. The determiner 104 may notify the operating criterion to be used to the timing determiner 101 to cause the timing determiner 101 to specify the corresponding threshold value. In addition, the determiner 104 notifies identification information on the reference point to the timing determiner 101. The timing determiner 101, which has received the instruction from the determiner 104, searches the first storage 102 for feasibility data that is associated with the identification information on the reference point (step 407). The timing determiner 101 calculates elapsed time at which the adequacy exceeds the threshold value soonest after a current elapsed time counted by the time keeper 103 (step 408). The timing determiner 101 notifies the calculated elapsed time to the time keeper 103 (step 409). Note that the adequacy has exceeded the threshold value by the current time, the flow may skip the next step 410 and proceeds to step 412. Alternatively, the timing determiner 101 may be configured to determine elapsed time until the adequacy exceeds threshold value next time from a state of being equal to or less than the threshold value.

After the notification to the time keeper 103, the power controlling function of the communicating device 100 (assumed to be included in the determiner 104 in the description of this flow that) switches a part or all of the portions of this communicating device 100 relating to the communication into then sleeping state (step 410). For example, the power controlling function may turn off power supply to all or a part of the communicator 108. Note that portions that have an influence on user experience, such as ones that implement the user interface, may be configured to keep operating as usual.

In addition, the elapsed time calculated by the timing determiner 101 may be presented to the user of the communicating device 100 through the user interface (not shown) as an estimated time period taken to start the communication. This allows the user to predict how much time it takes from that point to start the communication. Instead of the elapsed time, a time point after the elapsed time may be calculated and presented to the user.

The time keeper 103 determines whether the elapsed time up to that point matches the elapsed time notified from the timing determiner 101 while continuing counting, and if they match, outputs the notification of coming the determination timing to the determiner 104 (step 411). The determiner 104 that receives the notification from the time keeper 103 causes the processing sections in the sleeping state to return from the sleeping state (the same step 411).

Next, the determiner 104 performs the simple evaluation of the communication environment (step 412). The determiner 104 collects pieces of information necessary to calculate the adequacy via the communication interface 106, the sensor 110 or the like and calculates the adequacy. The pieces of information to be collected and the method of collecting them differ according to the detail of the adequacy. For example, if the adequacy is based on the reception strength of a radio wave used in the communication, the determiner 104 performs a process of searching for a device (connection destination) to which a radio wave is to be transmitted, receiving a radio wave, and checking thereafter the strength of the radio wave (this corresponds to a scanning process of an access point, or the like in a wireless LAN of the IEEE 802.11. The method of scanning may be either an active scan or a passive scan. Note that, in the case of passive scan, no new signal will be transmitted for the search).

The determiner 104 compares the calculated adequacy with the threshold value determined in step 402 (step 413). The determiner 104 determines whether the adequacy exceeds the threshold value (step 414), and if the adequacy exceeds the threshold value (YES in step 414), the determiner 104 shifts to the detailed evaluation of the communication environment. If the adequacy does not exceed the threshold value (NO step 414), the flow returns to step 407. In step 407 back from step S414, the feasibility data that has been searched for by the timing determiner 101 is determined to continue to be used, and the flow proceeds to step 408. In step 408, the timing determiner 101 determines elapsed time at which the adequacy exceeds the threshold value soonest next time based on the feasibility data. Note that the adequacy has exceeded the threshold value by the current time, the flow may skip the next step 410 and proceeds to step 412. Alternatively, the timing determiner 101 may be configured to determine elapsed time until the adequacy exceeds threshold value next time from a state of being equal to or less than the threshold value.

The determiner 104 first collects, in the detailed evaluation of the communication environment, information to determine whether the environment evaluation rule in the second storage 105 is satisfied (step 415). The determiner 104 collects the information necessary to determine the satisfaction of the environment evaluation rule from the communication interface 106, the sensor 110 or the like and evaluates the environment evaluation rule. Here, it is assumed that the information to be collected is appropriately determined for each environment evaluation rule. The determiner 104 collects the information in conformity with the environment evaluation rule. For example, as described above, if the environment evaluation rule contains the speed of the data link layer, the determiner 104 collects the link speed of the communication channel established by the communication interface 106.

The determiner 104 determines whether to perform the communication based on the information acquired for the detailed evaluation of the communication environment and the environment evaluation rule (step 416). For example, if a condition that the speed of the data link layer is equal to or more than a certain value is defined in the environment evaluation rule, the determiner 104 calculates the speed of the data link layer based on the acquired information, and determines whether the calculated speed is equal to or more than the certain value. The determiner 104 determines that the communication is feasible if the speed is equal to or more than the certain value, and determines that the communication is infeasible if the speed is less than the certain value.

If the determiner 104 determines that the communication is infeasible as a result of the detailed evaluation (NO in step 417), the flow returns to step 407, and the operation similar to the case where the flow returns from step 414 to step 407 is performed. In contrast, if determining that the communication is feasible (YES in step 417), the determiner 104 determine to allow performing the communication, and outputs an instruction to perform the communication to the communicator 108 (the same step 418). The communicator 108 performs the communication relating to a communication request according to the instruction to perform the communication (step 418).

If there is any other communication request to be executed after performing the communication by the communicator 108 (YES in step 419), the flow returns to step 412, and the simple evaluation and the detailed evaluation of the communication environment are performed.

In this re-evaluation, the evaluations are not necessarily evaluated every time for ones which take a long time to evaluate (e.g. calculating a throughput), and ones the evaluation results of which do not change much (e.g., the BSSID of the connected wireless LAN network). Note that intervals to perform the re-evaluation may be determined by any method. If there is no other communication request to be executed, the flow returns to step 407 again.

Subsequently, if there is not any communication requests at the time when the flow proceeds to step 418 of performing the communication, the step may be skipped.

Lastly, this process terminates at a timing at which the elapsed time recorded in the feasibility data that is the object of keeping time in the time keeper 103 reaches. Note that this process can be explicitly interrupted by an instruction from the user via the user interface.

As described above, in the first embodiment, the timing to evaluate the communication environment (determination timing) is determined, with the start point set to the time point at which the mobile terminal is positioned at the reference point, using the feasibility data in which the elapsed time is associated with the adequacy. The determination timing can be thereby determined at a specific time point, thereby reducing energy necessary to evaluate the communication environment, which can in turn achieve the reduction in the energy consumption of the entire device. In addition, it is expected to reduce actual energy necessary to manage the determination timing because the determination timing can be readily determined based on the threshold value and it is enough to only count with the time keeper 103 until the determined determination timing comes. In addition, since, the detailed evaluation based on the environment evaluation rule is performed in addition to the simple evaluation based on the adequacy, the communication environment can be evaluated taking indicators other than the adequacy into consideration. In such a manner, both the reduction of the amount of energy consumed and the optimization of the communication timing can be achieved.

### Second Embodiment

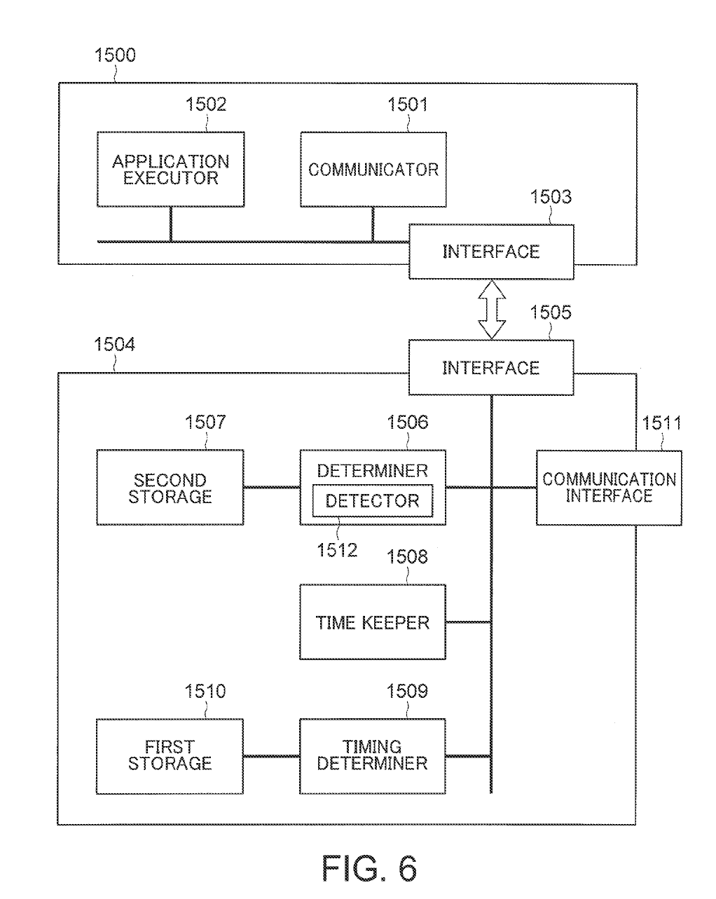

FIG. 6 is a functional block diagram of a communicating device in a second embodiment. The communicating device in the present embodiment includes a host 1500 and an interface board 1504. The sections 101 to 109 shown in FIG. 1 are separated and disposed into the host 1500 and the interface board 1504.

The host 1500 includes a communicator 1501, an application executor 1502, and an interface 1503. The communicator 1501 and the application executor 1502 correspond the communicator 108 and the application executor 107 in the first embodiment. The interface 1503 is an interface for the connection with the interface board 1504. For example, interfaces compliant with standards such as a USB, SDIO, and PCI Express® are applicable.

The interface board 1504 includes an interface 1505, a determiner 1506, a second storage 1507, a time keeper 1508, a timing determiner 1509, a first storage 1510, and a communication interface 1511. The determiner 1506 includes a detector 1512. The interface 1505 is a section for the connection with the host 1500. The components 1506 to 1512 correspond the respective section having the same names in the first embodiment. The timing determiner 1509, the determiner 1506, and the detector 1512 forms a timing determining device.

The basic operation of the communicating device in FIG. 6 is the same as that in the first embodiment. The communicating device differs from the first embodiment in that the application executor 1502 and the communicator 1501 exchange information with the determiner 1506 to the communication interface 1511 via the interfaces 1503 and 1505.

In addition, in the sleeping state of step 410 in FIG. 5, when the host 1500 need not perform communication, the interface board 1504 may be caused to shift to a state that less power is consumed than in communication. This state is achieved by, for example, only the time keeper 1508 operating and the other sections shifting to a low-power-consumption state that less power is consumed in the interface board 1504. In the low-power-consumption state, power supply to at least a part of the sections may be cut off. Similarly, if only the interface board 1504 operates and the host 1500 need not operate, the host 1500 may shift to the low-power-consumption state.

If the interface board 1504 has shifted to the low-power-consumption state, the host 1500 controls the interface board 1504 (e.g., turning on the power supply or transmitting certain signals to cause the sections to return to an operating state) to return to an operating state.

In contrast, if the host 1500 has shifted to the low-power-consumption state, the host 1500 returns to the original state (a state of normal operation) by an interrupt signal or the like from the interface board 1504.

Both the interface board 1504 and the host 1500 may shift to the low-power-consumption state.

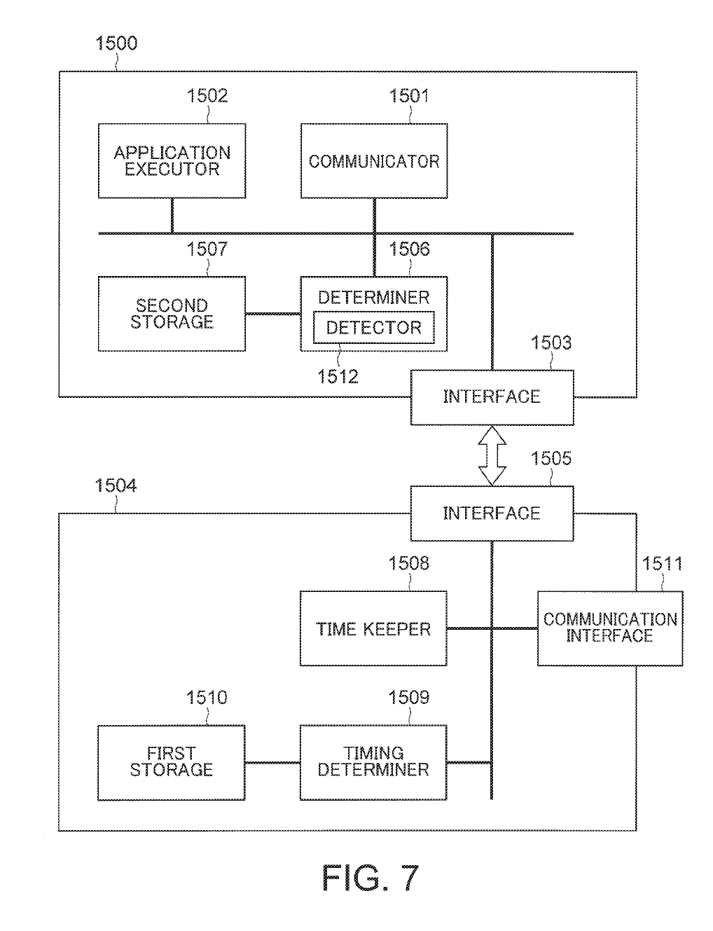

FIG. 7 is the other functional block diagram of the communicating device in the second embodiment. The disposition of the sections differs from FIG. 6. More specifically, the difference from FIG. 6 is in that the second storage 1507 and the determiner 1506 are disposed in the host 1500. The timing determiner 1509, the determiner 1506, and the detector 1512, which are components forming the timing determining device, are separated and disposed into the host 1500 and the interface board 1504.

As with the case of FIG. 6, the exchanges via the interfaces 1503 and 1505 occurs if the host 1500 and the interface board 1504 needs to exchange information. In the sleeping state, if the sections of the host 1500 shift to the low-power-consumption state, the host 1500 may be configured to return to the operating state when the time keeper 1508 completes the keeping time and makes a notification to the determiner 1506. If the sections of the interface board 1504 shift to the low-power-consumption state, shifting to the low-power-consumption state occurs by only the time keeper 1508 operating and the other sections shifting to the low-power-consumption state. Both the interface board 1504 and the host 1500 may shift to the low-power-consumption state.

### Third Embodiment

The present embodiment differs in the operation of the timing determiner that is described in the first or second embodiment. More specifically, the determining method of the determination timing differs. The block diagram of the present embodiment is similar to that of the first or second embodiment. The description will be made below with reference to the block diagram of FIG. 1.

In the first or second embodiment, the timing determiner 101 calculates the elapsed time at which a degree of adequacy exceeding the threshold value can be obtained at the soonest timing after the current elapsed time kept by the time keeper 103 (referred to as elapsed time T1 hereafter). In contrast, in the present embodiment, the timing of elapsed time T2, which is earlier than the elapsed time T1 by ΔT, is output as the determination timing. The timing of elapsed time TX may be hereafter referred to as a timing TX (X is an integer).

Here, ΔT is an offset time that is determined by a predetermined method. The predetermined method includes, for example, a method of determining ΔT to be a constant, and a method of determining ΔT according to the moving state of the mobile terminal. The method of determining ΔT to be a constant, is a method of outputting a timing T1-ΔT_{fix} that is earlier than T1 by a certain time in any circumstance. The method of determining according to the moving state includes, for example, a method of making ΔT a large value of ΔT_{long} in the case where environmental changes are rapid with the elapse of time (the case of using a transportation (e.g., an automobile)), and making ΔT a smaller value of ΔTₛₕₒᵣₜ in the case where the environmental changes are slow (the case of walking). More specifically, the moving state of the mobile terminal may be predicted based on information from the other communication interface (not shown), an accelerometer or sound sensor, the GPS, and the like, and ΔT may be determined according to the predicted moving state (e.g., using a transportation and walking).

The time keeper 103 receives the notification of information on the timing T2 from the timing determiner 101, and sets an internal timer such that it expires when the timing T2 reaches or passes. The time keeper 103 outputs a notification to the determiner 104 when the internal timer expires.

When receiving the notification from the time keeper 103, the determiner 104 performs, as with the first or second embodiment, a determining process of whether the environment is suitable to perform the communication (the simple evaluation, the detailed evaluation, or both of them). If the environment is determined to be suitable at this point, the determiner 104 instructs the communicator 108 to perform the communication. In contrast, if the environment is unsuitable, the processing returns to the timing determiner 101 again (the flow returns to step 407 of FIG. 5).

Here, time taken for the determiner 104 to perform the determining process is assumed to be sufficiently shorter than the offset time ΔT. The timing determiner 101 specifies again the elapsed time at which a degree of adequacy exceeding the threshold value is obtained at the soonest timing after the current elapsed time kept by the time keeper 103, and the elapsed time turns out to be the same as the previous time, the elapsed time T1. Note that the timing determiner 101 grasps that it outputs the timing T2 in the processing last time, and then determines this time T3 satisfying T2<T3<T1 and outputs the timing T3. To the method of determining this T3, the same idea as the above-mentioned determining method of ΔT can be applied.

The above-mentioned series of processes (from the timing determination up to the determining process) may be performed a plurality of times. In this case, the outputs from the timing determiner 101 are a sequence of timings TX (X is a number) satisfying a condition of T2<T3<T4<T5 . . . <T1. These timings T3, T4, T5, . . . may be adjusted based on above-mentioned moving state (e.g., on foot, by bicycle). Alternatively, the sequence of timings TX may be set so as to shorten the intervals thereof as they are closer to the elapsed time T1.

That is, the sequence of timings TX may be set to satisfy T3−T2>T4−T3>T5−T4.

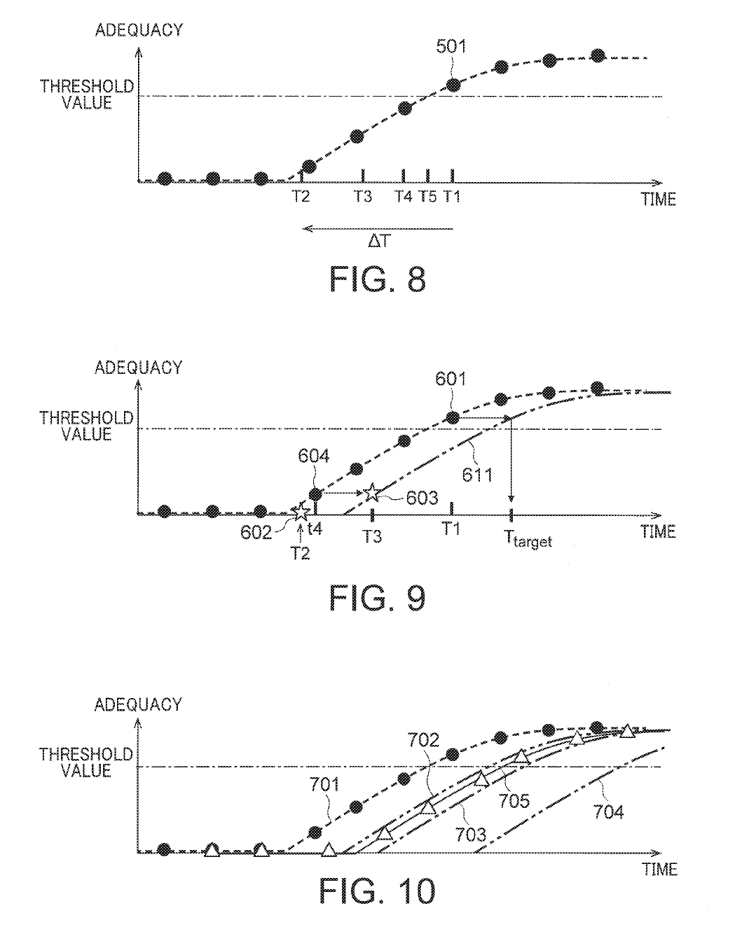

FIG. 8 schematically shows an operation image of the timing determiner 101 in the third embodiment. Assume that points shown by solid-black-circle marks in FIG. 8 are pieces of information on the feasibility data stored in the first storage 102. At a point 501 corresponding to the elapsed time T1, the adequacy first exceeds the threshold value after the mobile object is positioned at the reference point. In the present embodiment, the timing determiner 101 specifies the elapsed time T2 that is earlier than the elapsed time T1 by ΔT, and notifies the timing of the elapsed time T2 as the first determination timing to the time keeper 103. Subsequently, with the determining process (the simple evaluation and the detailed evaluation) performed a plurality of times, the determination timings are also output a plurality of times. In the example of the drawing, the determination timings are output in the order of T2, T3, T4, T5, and T1. At this point, the intervals between the determination timings to be output become shorter as the timings are closer to the elapsed time T1. In the example of FIG. 8, the intervals satisfy T3−T2>T4−T3>T5−T4. This allows the environment feasible to perform the communication to be detected with no or less delay even if an error occurs between the feasibility data and an actual environment in the vicinity of the elapsed time T1 to be a target.

In FIG. 8, the error between the feasibility data and the actual environment is cancelled by outputting the determination timings prior to the elapsed time T1, and the following mode to be described is to cancel the error by modifying the feasibility data temporarily. FIG. 9 shows an example of modifying the feasibility data as to temporarily translate the graph of the feasibility data. This process is performed by the timing determiner 101.

As with the example of FIG. 8, assume that points shown by the solid-black-circle marks are the pieces of information on the feasibility data stored in the first storage 102. First, assume that an adequacy equivalent to a solid-white-star mark 602 is obtained when the determination (the simple evaluation) is performed at the timing T2 earlier by ΔT than a point 601 (the timing T1) at which the adequacy exceeds the threshold value. In addition, assume that an adequacy equivalent to a solid-white-start mark 603 is obtained at T3 being the next determination timing.

At this point, the solid-white-start mark 603 matches a solid-black-circle mark 604 that is stored in the first storage 102. Thus, a different δt between elapsed time (defined as t4) at which data on the solid-black-circle mark 604 is recorded and the timing T3 is calculated as an error, and the entire feasibility data is modified so as to be translated by δt using the value δt. That is, elapsed time corresponding to each adequacy of the feasibility data is modified into a value with δt added thereto. As a result, for example, T1 is changed to T_{target} (=T1+δt). A graph 611 of the modified feasibility data is shown in FIG. 9. If a plurality of determining processes are performed up to T_{target} after the modifying, the intervals between the determination timings can be changed by the above-mentioned method (shortened as the timing comes close to T_{target}). Although the entire feasibility data is translated here, only the data later than the solid-black-circle mark 604 may be translated. Although the translation of the feasibility data is assumed to be valid only during the process of this feasibility data this time, there is also a method of updating the feasibility data itself, as will be described hereafter.

In this example, the adequacy shown by the solid-white-start mark 603 matches the adequacy shown by the solid-black-circle mark 604, but an adequacy matching the calculated adequacy is not always contained in the feasibility data. Thus, elapsed time corresponding to the calculated adequacy may be calculated by interpolating the feasibility data, and a difference between a determination timing (elapsed time) at which the adequacy is calculated and the calculated elapsed time may be calculated as the error R.

In addition, in this example, the above-mentioned error δt is calculated from one measurement point (a determination timing and a calculated adequacy), but the error δt may be calculated for a plurality of measurement points, the feasibility data may be modified using their average value δtₐᵥₑ. That is, elapsed time corresponding to each adequacy in the feasibility data may be changed by δtₐᵥₑ. In addition, in this example, the feasibility data is translated in a temporally backward direction, but this example can be similarly applied to the case of a translation in a temporally forward direction. That is, the value of δt or δtₐᵥₑ may be negative.

Furthermore, the feasibility data stored in the first storage 102 may be corrected by storing the number of translations and the amount of movement (or the modified feasibility data) in the first storage 102 or the other storage medium such as a memory, and processing them statistically. This process is performed by the timing determiner 101.

For example, as shown in FIG. 10, assume that three translations (modifying processes) are performed for the feasibility data (shown by the solid-black-circle marks and the graph 701 by a line passing them). Graphs 702, 703, and 704 of the translated feasibility data are shown. These translations may be a plurality of translations performed from the start to the end of the processing of one feasibility data, or may be, in the case where the feasibility data is processed a plurality of times in the past, a set of the translations performed in the respective processing.

The corrected feasibility data is obtained by subjecting the original feasibility data and the respective translated feasibility data to weighted average. The same value may be given to weights for the weighted average, or heavier weights may be given to later or earlier feasibility data. A graph 705 of the corrected feasibility data (solid-white-triangle marks and a line passing them) is shown.

The method of correcting the feasibility data may be one in which the correction is performed whenever the feasibility data is modified a number X (X is an integer more than zero) of times, or may be one in which the correction is performed only when the magnitude of the error (δt) becomes equal to or larger than a threshold value that is determined in advance.

In the example described above with reference to FIG. 10, the intervals between the determination timings are shortened gradually with respect to the timing T1 at which the adequacy exceeds the threshold value first, but the intervals between determination timings may be changed based on how the adequacy comes close to the threshold value.

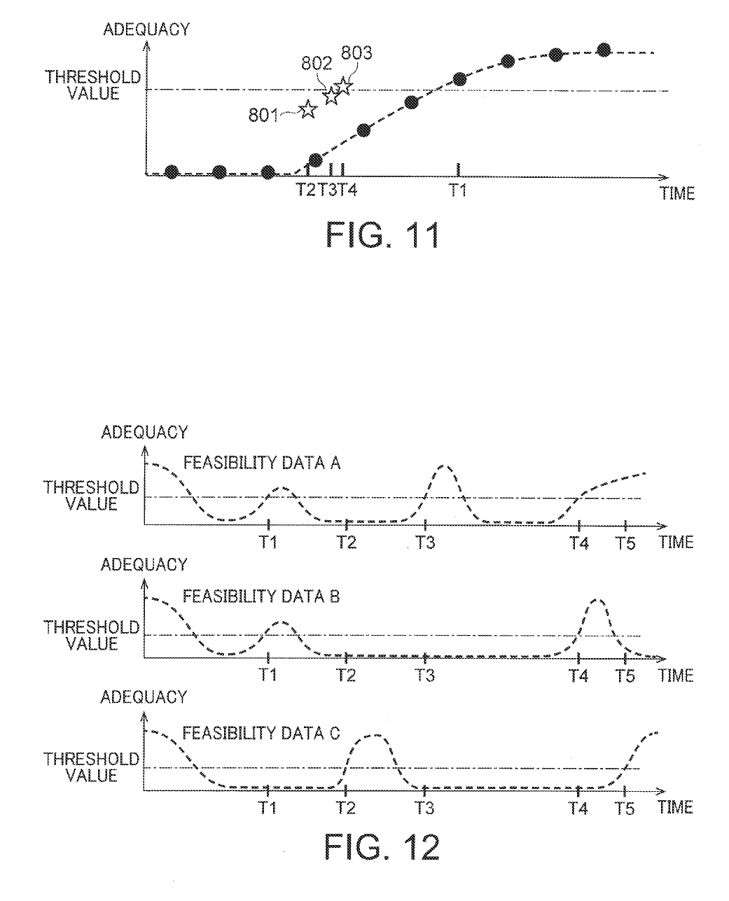

For example, as shown in FIG. 11, assume that data on a solid-white-start mark 801 is obtained as a result of the determination at the timing T2 taking into consideration a certain width ΔT with respect to the timing T1 at which the adequacy exceeds the threshold value first. The adequacy shown by the solid-white-start mark 801 is a value that already comes close to the threshold value, and the adequacy may shortly exceed the threshold value. Thus, rather than gradually shortening the intervals between the determination timings toward the timing T1 as described thus far, the intervals between the determination timings are immediately shortened. That is, the intervals between the determination timings are determined according to the difference between the adequacy and the threshold value, where the interval is made to be shorter for a smaller difference. The example of FIG. 11 shows determination timings T3 and T4 that the timing determiner 101 determines with such a short interval, and values of adequacy 802 and 803 calculated at the determination timings T3 and T4 through the simple evaluation. Note that if the result of the determination at the timing T3 shows that the adequacy becomes small in a direction away from the threshold value, the intervals between the determination timings may be widened. This can suppress useless energy consumption.

In the present embodiment, performing only the simple evaluation a plurality of times with changes in the environment can suppress the error on the time axis to be small, the error occurring from the difference between the feasibility data that is obtained in advance and a present communication environment. This allows a suitable communication environment to be found more effectively, which can in turn suppress the energy consumption of the communicating device 100.

### Fourth Embodiment

As described in the first embodiment, the plurality of feasibility data sharing the reference point may be stored in the first storage 102. The plurality of feasibility data are, for example, feasibility data A of the case where a user leaves the user's own house and directly goes to an office, feasibility data B of the case where the user leaves the user's own house and goes to the office via a nursery, and feasibility data C of the case where the user leaves the user's own house and goes to a nearby shop. FIG. 12 shows an example in which the feasibility data A, the feasibility data B, and the feasibility data C are drawn in the form of a graph.

In the present embodiment, a method of narrowing down feasibility data to be used from among these feasibility data. A first method is a method of narrowing the feasibility data down to possible one using a timing at which the adequacy exceeds the threshold value. A second method is a method of narrowing the feasibility data down to one to be used by increasing the amounts of information on the feasibility data. Each method will be described below.

To narrow down the feasibility data with the first method, the timing determiner 101 specifies elapsed time at which the adequacy exceeds the threshold value at the closest timing to the current time, in a constellation of candidate feasibility data, and notifies the elapsed time to the time keeper 103. In the example of FIG. 12, the adequacy exceeds the threshold value at elapsed time T1 in both of the data A and the data B, and thus T1 is notified. Similarly, the timing determiner 101 specifies elapsed time at which the adequacy exceeds the threshold value at the next closest timing, and notifies the elapsed time to the time keeper 103. Elapsed time T2 in the data C then corresponds to the elapsed time, and thus the elapsed time T2 is notified. Subsequently, a similar process is repeated. As a result, elapsed times are notified in the order of T1, T2, T3, T4, and T5.

Using the values of adequacy calculated through the simple evaluation at respective timings (elapsed times) T1 to T5, feasibility data to be a candidate is then narrowed down. In each timing of the simple evaluation, H denotes the case of exceeding the threshold value, and L denotes the case of not exceeding. In this case, the data A should be H-L-H-H-H, the data B should be H-L-L-H-L, and the data C should be L-H-L-L-H, at the respective timing. These are referred to as correct data. Meanwhile, a sequence of elements containing H or L is also created for each feasibility data from the values of adequacy calculated in the simple evaluation. These are referred to as evaluation-result data. By comparing the evaluation-result data with the correct data and eliminating the feasibility data in which an inconsistency arises between them, the feasibility data can be narrowed down to specific one.

Here, the feasibility data may be eliminated at the time when an inconsistency arises between both the data, or may be eliminated only if the inconsistencies arise a certain number of times or more in a row, assuming the error of determination by the simple evaluation. In the former case, if the first evaluation result is H, the feasibility data C is eliminated at this point, and subsequently, if the second and third evaluation results are L-L, the feasibility data A is eliminated at this point. In contrast, in the latter case, if the data is made to be eliminated when, for example, the inconsistencies arise twice in a row, the data C is to be eliminated at the time when the first and second evaluation results are obtained as H-L.

Subsequently, the second method will be described. The second method is based on the premise that the feasibility data is stored in the first storage 102 together with environment information at the time of obtaining the feasibility data being associated with elapsed time information. For example, if the feasibility data is based on the intensity of a radio wave from an access point of wireless LAN compliant with the IEEE 802.11, for example, information on the SSID, channel, and encryption of a network provided by the access point, or the BSSID and the like of the access point are stored as the environment information, being associated with each adequacy in the feasibility data.

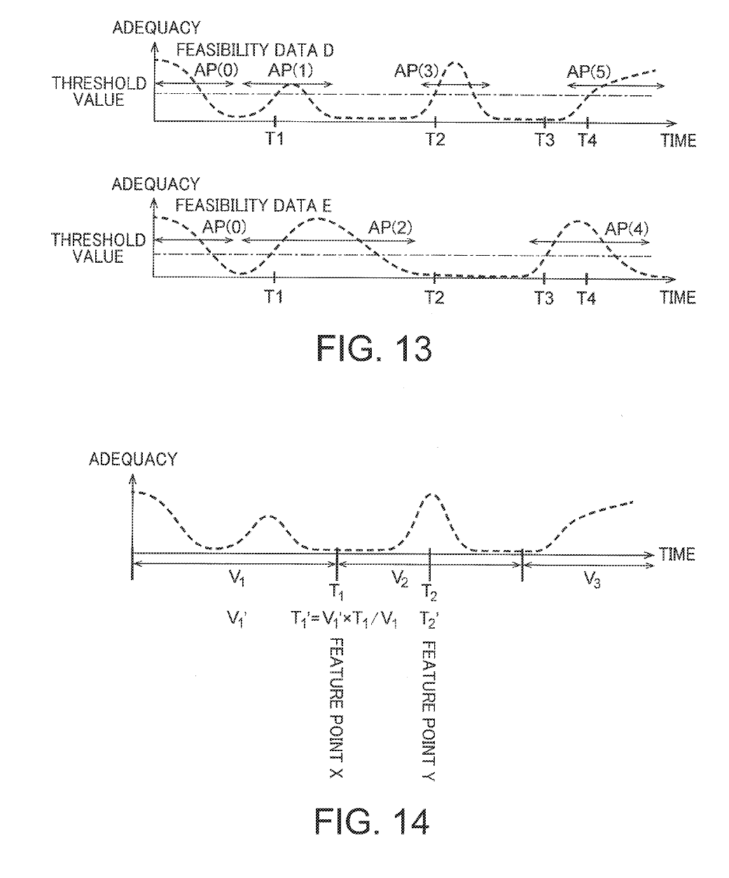

FIG. 13 shows feasibility data D and feasibility data E, and an example of information on an access point (AP) as the environment information associated with these data. In the feasibility data D, pieces of information on access points AP(0), AP(1), AP(3), and AP(5) are obtained within respective ranges drawn by corresponding lines having double-headed arrows. In the feasibility data E, pieces of information on access points AP(0), AP(2), and AP(4) are obtained within respective ranges drawn by corresponding lines having double-headed arrows. The pieces of AP information are detected in the order of AP(0)→AP(1)→AP(3)→AP(5) in the feasibility data D, and in the order of AP(0)→AP(2)→AP(4) in the feasibility data E, respectively.

In the above-described first method, both of the feasibility data D and the feasibility data E cannot be narrowed down by the comparison with the threshold value because both of the values of adequacy therein exceed the threshold value at the elapsed time T1. In contrast, in the second method, the determiner 104 obtains the pieces of information on APs via the communication interface 106 as well when performing the simple evaluation at the timing (elapsed time) T1. For example, the pieces of information on APs are obtained as well at the timing T1. Assume that the piece of information on the AP(1) can be obtained. The AP information at the timing T1 in the feasibility data is the AP(1) in the feasibility data D, and the AP(2) in the feasibility data E. Therefore, even in the case where both of the values of adequacy calculated through the simple evaluation exceed the threshold value, the feasibility data can be narrowed down to the feasibility data D because the AP information at the timing T1 in the feasibility data D is the AP(1), which matches the obtained piece of information on AP.

Note that, in detecting the access point, information on an unknown access point may be obtained. In this case, a new feasibility data may be created, or a piece of environment information associated with the feasibility data may be corrected. At this point, the newly created feasibility data or the corrected piece of environment information may be immediately reflected in the first storage 102, or may be reflected after the same result is obtained a certain number of times or more.

In addition, the narrowing down the candidates described here can be applied to not only the case where the timing determiner 101 outputs the timing at a timing at which the adequacy exceeds the threshold value, but also, like a third embodiment, the case of outputting the timing at time earlier than the timing by ΔT, or the case of outputting a plurality of timings prior to the timing in such a manner as to gradually shorten intervals (performing the simple evaluation a plurality of times). This can be applied by appropriately managing which candidate each timing is derived from.

As seen from the above, in the present embodiment, a suitable feasibility data can be selected by controlling the timings of the simple evaluation and taking the results of the simple evaluation into account even in the case where there are a plurality of feasibility data resembling a current circumstance change. This allows the communication to be performed at a more appropriate communication timing, reducing the energy consumption of the communicating device 100.

### Fifth Embodiment

In a fifth embodiment, the error between an feasibility data and an actual communication environment is reduced by correcting elapsed time managed (kept) by the time keeper 103 based on measurement information on the mobile terminal or the current position of the user. Some methods therefor are conceivable. Two examples will be described below.

A first method is a method of bringing forward or backward the elapsed time managed by the time keeper 103 according to the moving pattern or the speed of movement of the user.

For example, the timing determiner 101 infers the moving pattern (e.g., on foot, by bicycle, by automobile) using a value from the accelerometer or the like, and adjusts the elapsed time using the result of the inference. The elapsed time managed by the time keeper 103 may be adjusted by, for example, multiplying the elapsed time by a coefficient according to the inferred moving pattern. In the first storage 102, information on the coefficient according to the moving pattern is stored being associated with the feasibility data.

Alternatively, the elapsed time managed by the time keeper 103 may be adjusted using a value obtained by calculating the speed of movement of the user. For example, the speed of movement on foot is calculated by recoding the number of steps using the accelerometer as a pedometer. In the first storage 102, information on a speed at the time when the feasibility data is obtained or the average of the speeds is stored being associated with the feasibility data. The elapsed time managed by the time keeper 103 is then adjusted according to the ratio of the calculated speed to a speed represented by the information associated with the feasibility data. The speed of movement may be directly calculated using the GPS instead of the accelerometer. Alternatively, the speed of movement may be inferred using information that can be regularly observed (e.g., in the case where base stations using a communications system other than the wireless LAN are installed at substantially regular intervals, positional information or identification information (beacon) that regularly output by the base stations)).

FIG. 14 shows an example in which the elapsed time managed by the time keeper 103 is adjusted by calculating the speed of movement of the user. Assume that elapsed time up to a feature point X is calculated to be T1 through the keeping time by the time keeper 103. The feature point X is a position satisfying a predetermined condition (e.g., a position at which a value from the sensor satisfying the condition). In addition, assume that the average speed of movement up to the feature point X is stored as V1 being associated with the feasibility data. In addition, assume that the speed of movement measured using the sensor or the like is V1′. In this case, the elapsed time counted by the time keeper 103 may be multiplied by V1′/V1. That is, the elapsed time as of the feature point X is corrected to T1′=T1×V1′/V1. The time keeper 103 thereafter counts a value obtained by multiplying the elapsed time by V1′/V1. Note that, the sensor such as an accelerometer or a GPS sensor is preferably caused to operate at an appropriate timing for an appropriate time period because the continuous operation of the sensor increases the amount of energy consumed.

A second method is a method of adding information to the feasibility data to make it easy to specify a position. For example, identification information representing a characteristic point (e.g., a certain landmark, a large intersection to be a key, or an access point of a public wireless LAN) is stored in the feasibility data being associated with elapsed time at which the mobile terminal is positioned at the characteristic point, and in addition, a value (e.g., positional information by the GPS or SSID) obtained by causing at least one sensor (e.g., the GPS), the communication interface 106, or the like to operate at the position or in the environment, is recorded.

The timing determiner 101, when detecting that the elapsed time kept by the time keeper 103 matches (or comes closer to) elapsed time corresponding to the feature point added to the feasibility data, via the determiner 104, obtains a value from the sensor or the like, and detects whether the mobile terminal is positioned at the feature point by comparing the obtained value with the value from the sensor or the like that is stored in the first storage 102 in advance. The feature point is a position at which a predetermined condition is satisfied (e.g., a position at which a value from the sensor satisfies the condition). If the mobile terminal is detected being positioned at the feature point, the current elapsed time of the time keeper 103 is corrected to elapsed time corresponding to the feature point added to the feasibility data. For example, as shown in FIG. 14, assuming that elapsed time corresponding to a feature point Y is T2 and elapsed time kept by the time keeper 103 is T2′, the elapsed time T2′ of the time keeper 103 is changed to T2. In this method, the elapsed time is corrected for each feature point, which can reduces influence of the accumulation of errors.

### Sixth Embodiment

The present embodiment is characterized in that information on use timings of this communicating device by the user are associated with feasibility data stored in the first storage 102.

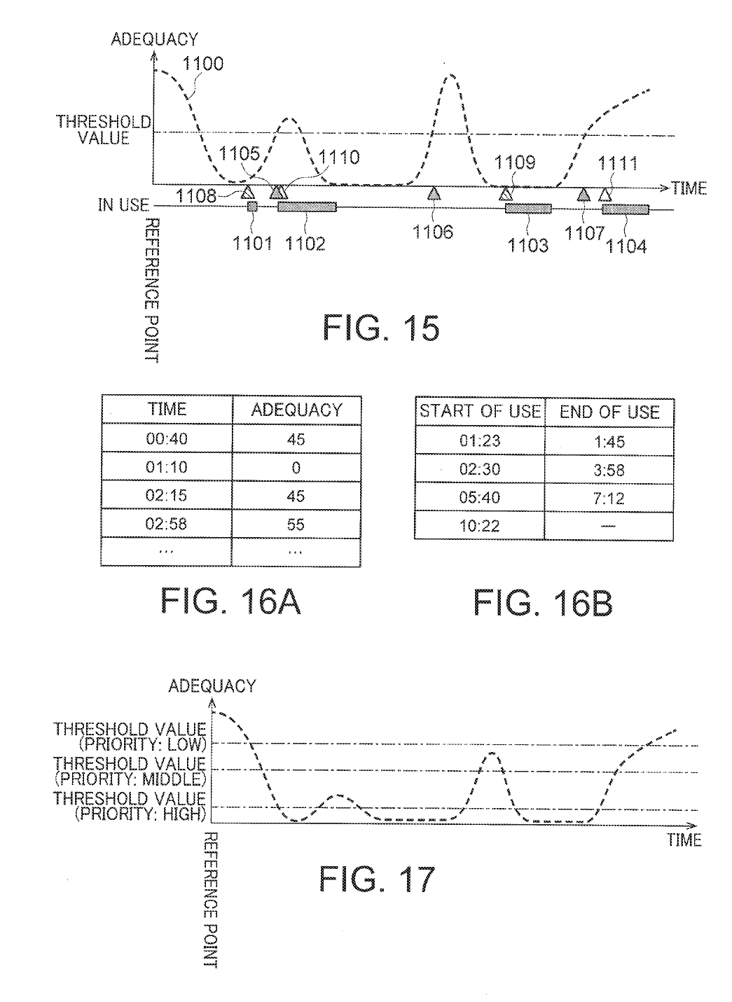

FIG. 15 schematically shows feasibility data stored in the first storage 102, and information on the use timings. In addition to the feasibility data described thus far (a graph 1100 of FIG. 15), information representing whether the user uses this communicating device is added. Ranges covered by rectangular frames 1101 to 1104 disposed on a horizontal line having a phrase “in use” at the left end, means that this communicating device is in use. Here, the term “in use” refers to a state that the user of this communicating device performs active operations through a user interface such as a screen.

FIGS. 16A and 16B show a specific example of the feasibility data and information on use timings in a tabular form. FIG. 16A shows the feasibility data, and FIG. 16B shows the information on the use timings. In FIG. 16B, time periods each specified by two timings of the start of use and the end of use indicate that this communicating device is in use. This is merely an example, and may be a data format other than the data format shown here. In addition, the granularity of recording shown in FIGS. 16A and 16B are for illustration, and an actual granularity may be made to be higher.

In the present embodiment, the timing determiner 101 not only outputs the determination timings at which the feasibility data exceeds the threshold value, but also outputs the determination timings taking the use timings by the user into consideration. For example, the value of determination timing to be output is determined such that the simple evaluation has already been performed at the time when (or immediately before) this communicating device is used.

The description will be made more specifically with reference to FIG. 15. The determination timings (the timings of exceeding the threshold value) that are output according to the other embodiments described thus far are shown by solid-black-triangle marks 1105, 1106, and 1107. Next, the determination timing that are output taking the use timings by the user are shown by hatched-triangle marks 1108 and 1109, and solid-white-triangle marks 1110 and 1111. These four points 1108 to 1111 are start timings (or immediately before them) of the use by the user. In the present embodiment, the timing determiner 101 operates so as to consecutively output the determination timings shown by the solid-black-triangle marks, the hatched-triangle marks, and the solid-white-triangle marks to the time keeper 103. Note that the determination timings shown by the solid-white-triangle marks 1110 and 1111 may not be output because it is understood from the feasibility data that they are timings after exceeding the threshold value.

Performing the simple evaluation at the determination timings shown by the hatched-triangle marks 1108 and 1109 brings about results that are roughly classified into two cases.

A first one is the case where the obtained evaluation result shows that performing the communication is infeasible. In this case, in the above-mentioned embodiments, the communication is not performed and the process of searching for the next determination timing is performed (refer to NO in step 414 of FIG. 5). In the present embodiment, however, this communicating device is highly likely used based on the use timings by the user, and thus the flow may be implemented so as to proceeds to the next process of the detailed evaluation (refer to step 415 of FIG. 5) even when the evaluation shows the infeasibility.

A second one is the case where the evaluation result shows that performing the communication is feasible. In this case, the flow may simply proceed to the next process of the detailed evaluation (refer to step 415 of FIG. 5).

Note that as described in the third embodiment, the original feasibility data can be corrected, and the method thereof has been already described in the third embodiment.

In addition, the process of shifting the determination timing by ΔT as described in the third embodiment can be also applied to the present embodiment. Evaluating the communication environment at the timing earlier by ΔT allows the communication to start immediately when an actual timing of use by the user comes.

In the present embodiment and the other embodiment described thus far, a difference in time arises from the occurrence of a communication request up to an actual permission for the communication (refer to the flow chart of FIG. 5). From the viewpoint of the amount of energy consumed, the timing of communication may be delayed until the best environment (e.g., a wireless LAN environment in the user's own house) is found, but an unlimited increase of delay significantly impairs usability. For this reason, in the present embodiment an improvement is made such that to perform the simple evaluation taking the timing of use by the user into consideration, enabling both of the usability and the reduction of the amount of energy consumed.

From this viewpoint, if there is still communication to be performed after the simple evaluation and the next detailed evaluation are performed based on the use timings by the user and the communication is performed, the communication may consecutively performed without returning to the simple evaluation. This corresponds to changing the shifting destination of step 419 to step 418 in the flow chart of FIG. 5. That is, if the evaluations of the communication environment are performed at a determination timing being the start of use by the user or immediately before the start of use, the communication may be consecutively performed without performing the evaluations (the simple evaluation and the detailed evaluation) again such that the communications held thus far can be performed as much as possible.

### Seventh Embodiment

In each embodiment described thus far, all the communication requests are treated equally without taking into consideration an application to be executed in the application executor 107. In the present embodiment, a control that takes into consideration the characteristics of an application, for each application is performed. The functional block diagram of the present embodiment is similar to that of FIG. 1 and will not be shown. The operation flow chart thereof is also similar to that of FIG. 5 and will not be shown.

In the present embodiment, the communicator 108 temporarily stores a communication request issued by an application associating the communication request with identification information on the application. In addition, the communicator 108 notifies the identification information on the application to the determiner 104. In addition, in the case where some kind of priority for the communication is set on an application side or the priority is held by the application itself, the communicator 108 may obtain information on the priority from the application side. In this case, the communicator 108 may notify the priority represented by the obtained information as the priority of the communication request, to the determiner 104. Alternatively, the communicator 108 may be configured to include a plurality of queues based on the priority, and to cause the determiner 104 to perform the determination starting with a communication request having a higher priority.

The determiner 104 acquires a corresponding environment evaluation rule from the second storage 105, based on application identifying information, the priority of the communication request, or both of them transmitted via the communicator 108. In acquiring the environment evaluation rule, the application identifying information is given a higher priority over the information on the priority. This allows the environment evaluation rule to be specified in a finer granularity. The determiner 104 performs the detailed evaluation based on the acquired environment evaluation rule, and allows communication requests held in the communicator 108 to be executed if they satisfy the environment evaluation rule. This is the same as in the embodiments described thus far.

In the present embodiment, in the case of using only the priority out of the application identifying information and the priority, communication requests classified under the same priority may be allowed to be executed in one determination (detailed evaluation). In contrast, when the environment evaluation rule is acquired for each application using the application identifying information, an individual determination (detailed evaluation) is needed. Note that, with respect to the detailed evaluation that takes a long time to evaluate the environment evaluation rule, the detailed evaluation is not necessarily performed for each communication request (since there is a case where the communication environment does not change much, as already described).

As seen from the above, specifying the environment evaluation rule to be used based on the identification information on or the priority of the application enables a control in conformity with the individual demand of the application.

### Eighth Embodiment

The seventh embodiment is described about the case of changing the environment evaluation rule to be used according to the application or the priority. The present embodiment will be described about the case where a timing of the simple evaluation that is performed in the previous step is changed according to the application or the priority. The application and the priority are the same as those in the seventh embodiment, and will not be described.

In the present embodiment, a threshold value for feasibility data is stored in the first storage 102 for each application or priority. FIG. 17 shows an example in which three threshold values are set to the feasibility data according to the respective priorities. A low threshold value is set for a priority of “high.” The number of times that the simple evaluation is performed is thus increased (i.e., the probability of performing the communication in the end is increased). In contrast, a high threshold value is set for a priority of “low.” The communication is thus to be performed only at a timing at which the simple evaluation is effectively performed. There is described here the example in which the threshold values are set according to the priority, but the threshold values can be set similarly according to the application. Alternatively, the threshold values can be set according to the combination of the application and the priority. In the first storage 102, these pieces of information are stored being associated with the feasibility data.

As with the seventh embodiment, the identification information on the application, the information on priority, or both of them are notified to the timing determiner 101 via the communicator 108. The timing determiner 101 selects threshold values according to the notified identification information, priority, or both of them, for the feasibility data that is selected as in the embodiments described thus far. The subsequent processes are similar to those of the embodiments described thus far.

As seen from the above, changing the timing of the simple evaluation according to the application or the priority enables the reduction of consumed energy while controlling the frequency of communication opportunities.

The timing determining device as described above may also be realized using a general-purpose computer device as basic hardware. That is, each function block (or each section) in the timing determining device can be realized by causing a processor mounted in the above general-purpose computer device to execute a program. In this case, the timing determining device may be realized by installing the above described program in the computer device beforehand or may be realized by storing the program in a storage medium such as a CD-ROM or distributing the above described program over a network and installing this program in the computer device as appropriate. Furthermore, the storage may also be realized using a memory device or hard disk incorporated in or externally added to the above described computer device or a storage medium such as CD-R, CD-RW, DVD-RAM, DVD-R as appropriate.

Furthermore, the timing determining device may include a CPU (Central Processing Unit), a ROM (Read Only Memory) and a RAM as one example of circuitry. In this case, each unit or each element in the timing determining device can be controlled by a CPU's reading out into a RAM and executing a program which is stored in a storage or ROM.

Also, the above-stated hardware configuration is one example and the timing determining device according to an embodiment can be realized by an integrated circuit such as a LSI (Large Scale Integration) or an IC (Integrated Circuit) chip set. The circuitry may comprise one circuit or a plurality of circuits or a system of circuits. Each function block in the timing determining device can be realized by a processor, individually, or a part or all of the function blocks can be integrated and realized by one processor. A means for the integrating the part or all of the function blocks is not limited to the LSI and may be dedicated circuitry or a general-purpose processor.

The terms used in each embodiment should be interpreted broadly. For example, the term “processor” may encompass a general purpose processor, a central processing unit (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, one or more microprocessors in conjunction with a DSP core.

As another example, the term “memory” may encompass any electronic component which can store electronic information. The “memory” may refer to various types of media such as random access memory (RAM), read-only memory (ROM), programmable read-only memory (PROM), erasable programmable read only memory (EPROM), electrically erasable PROM (EEPROM), non-volatile random access memory (NVRAM), flash memory, magnetic or optical data storage, which are readable by a processor. It can be said that the memory electronically communicates with a processor if the processor read and/or write information for the memory. The memory may be integrated to a processor and also in this case, it can be said that the memory electronically communication with the processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A timing determining device used in a mobile terminal, comprising:
processing circuitry configured to:
perform a detecting process of whether the mobile terminal is positioned at a reference point being a point at which a predetermined condition is satisfied for the mobile terminal;
employ feasibility data representing relationship between an adequacy of a communication environment and elapsed time from a start time point at which the mobile terminal is positioned at the reference point, estimate elapsed time until the adequacy satisfies a communication condition since the mobile terminal is positioned at the reference point and determine a timing of evaluating the communication environment according to an estimated elapsed time; and
determine whether to permit the mobile terminal to perform communication on basis of measurement of the communication environment at the timing determined.

2. The device according to claim 1, wherein
the communication condition defines that the adequacy exceeds a threshold value, and
the processing circuitry estimate the elapsed time until the adequacy exceeds the threshold value since the mobile terminal is positioned at the reference point.

3. The device according to claim 1, wherein the processing circuitry determines the timing of time that is shorter than the estimated elapsed time by a constant period of time.

4. The device according to claim 1, wherein the processing circuitry determines a plurality of the timings such that an interval between adjacent timings is made shorter as closer to an end timing of the estimated elapsed time since the mobile terminal is positioned at the reference point, and determines whether to permit the mobile terminal to perform the communication at each of the plurality of the timings.

5. The device according to claim 2, wherein the processing circuitry determines a plurality of timings such that an interval between adjacent timings is made shorter as the adequacy comes closer to the threshold value, and determines whether to permit the mobile terminal to perform the communication at each of the plurality of the timings.

6. The device according to claim 1, wherein the processing circuitry calculates the adequacy on basis of the measurement of the communication environment, and corrects the feasibility data according to a difference between a calculated adequacy and an adequacy corresponding to the timing determined in the feasibility data.

7. The device according to claim 1, wherein the processing circuitry performs the detecting process, based on at least one of information received at the mobile terminal from an external communicating device, and information obtained from a sensor equipped in the mobile terminal.

8. The device according to claim 1, wherein
feasibility data is prepared for each of a plurality of reference points, and
the processing circuitry detects that the mobile terminal is positioned at the one of the reference points,
the processing circuitry selects the feasibility data corresponding to the one of the reference points and employs the selected feasibility data.

9. The device according to claim 1, wherein
in a case that there are a plurality of feasibility data correspondingly to the reference point, the processing circuitry determines the timing for each of the plurality of feasibility data, and
the processing circuitry calculates the adequacy each time the timing is reached, and selects at least one feasibility data to be employed from the plurality of feasibility data according to comparison between the calculated adequacy and the adequacy corresponding to the timing in each of the plurality of feasibility data, and the processing circuitry employs the selected feasibility data from now on.

10. The device according to claim 1, wherein
in a case that there are a plurality of feasibility data correspondingly to the reference point, the processing circuitry determines the timing for each of the plurality of feasibility data, and
environment information is associated with the elapsed time in each feasibility data, and
the processing circuitry obtains environment information each time the timing is reached by using a communication interface or a sensor, and selects at least one feasibility data to be employed from the plurality of feasibility data according to comparison between the environment information corresponding to the timing in each feasibility data and the obtained environment information, and the processing circuitry employs the selected feasibility data from now on.

11. The device according to claim 1, wherein
the feasibility data contains information on a period of time for which a user uses the mobile terminal after being positioned at the reference point, and
the processing circuitry determines the timing based on the information on the period of time.

12. The device according to claim 11, wherein the processing circuitry determines the timing at which the user starts using the mobile terminal or a timing earlier than the timing at which the user starts using the mobile terminal by a constant period of time.

13. The device according to claim 1, wherein
the processing circuitry starts keeping time when it is detected that the mobile terminal is positioned at the reference point, manages elapsed time after starting the keeping time, and detects coming of the timing determined, wherein
after starting the keeping time, the processing circuitry detects a speed of movement or a moving pattern of the mobile terminal, and corrects the elapsed time managed by the keeping time according to the speed of movement or the moving pattern.

14. The device according to claim 1, wherein
the processing circuitry starts keeping time when it is detected that the mobile terminal is positioned at the reference point, manages elapsed time after starting the keeping time, and detects coming of the timing determined, wherein
the elapsed time in the feasibility data is associated with a feature point that is a position at which a second predetermined condition is satisfied for the mobile terminal, and
when the processing circuitry detects that the mobile terminal is positioned at the feature point, corrects the time managed by the keeping time based on the elapsed time associated with the feature point.

15. The device according to claim 1, wherein the processing circuitry performs the detecting process when an application operating in the mobile terminal issues a communication request.

16. The device according to of claim 1, wherein
an application to issue a communication request operates in the mobile terminal, and
the processing circuitry obtains information on the application, selects a communication condition to be used from among a plurality of communication conditions based on the obtained information, and determines the timing using the selected communication condition.

17. The device according to claim 1, wherein the processing circuitry calculates the adequacy based on the measurement of the communication environment, determines whether the calculated adequacy satisfies a first communication condition, and permits the mobile to perform communication when the first communication condition is satisfied, or does not permit the mobile to perform the communication when the first communication condition is not satisfied.

18. The device according to claim 17, wherein the processing circuitry calculates an indicator different from the adequacy on basis of a further measurement of the communication environment when the calculated adequacy satisfies the first communication condition, determines whether the indicator satisfies a second communication condition, and permits the mobile to perform communication when the second communication condition is satisfied, or does not permit the mobile to perform the communication when the second communication condition is not satisfied.

19. A timing determining method performed by a mobile terminal, comprising:
performing a detecting process of whether the mobile terminal is positioned at a reference point being a point at which a predetermined condition is satisfied for the mobile terminal;
employing feasibility data representing relationship between an adequacy of a communication environment and elapsed time from a start time point at which the mobile terminal is positioned at the reference point;
estimating elapsed time until the adequacy satisfies a communication condition since the mobile terminal is positioned at the reference point;
determining a timing of evaluating the communication environment according to an estimated elapsed time; and
determining whether to permit the mobile terminal to perform communication on basis of measurement of the communication environment at the timing determined.

20. A non-transitory computer readable medium storing a computer program stored therein, which causes a computer mounted in a mobile terminal when executed by the computer to perform processing of steps, comprising:
performing a detecting process of whether the mobile terminal is positioned at a reference point being a point at which a predetermined condition is satisfied for the mobile terminal;
employing feasibility data representing relationship between an adequacy of a communication environment and elapsed time from a start time point at which the mobile terminal is positioned at the reference point;
estimating elapsed time until the adequacy satisfies a communication condition since the mobile terminal is positioned at the reference point;
determining a timing of evaluating the communication environment according to an estimated elapsed time; and
determining whether to permit the mobile terminal to perform communication on basis of measurement of the communication environment at the timing determined.
